(19) United States
(12) Patent Application Publication
(10) Pub. No.: US 2005/0264708 A1
(43) Pub. Date: Dec. 1, 2005

(54) Liquid crystal display device

(76) Inventor: Chun-Chi Liao, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/680,095

(22) Filed: Oct. 8, 2003

(51) Int. Cl. H04N 5/64

(52) U.S. Cl. 348/794

(57) ABSTRACT

A liquid crystal display device includes a casing supporting a liquid crystal display screen and defining a plurality of receiving slots for respectively receiving memory cards and memory card connectors fixed inside the casing and associated with the receiving slots for engaging the memory cards received in the receiving slots. A data processing circuit is arranged in the casing for receiving and processing image data and sound data stored in the memory card and displaying the image on the liquid crystal display screen. The data processing circuit includes a compression/decompression circuit, an input selector, a data separator, a frequency multiplication processor, a converter and an amplifier for processing the image signals and a sound input port, a mixer, an amplifier and a speaker system for processing and broadcasting sound signals. The data processing circuit is additionally provided with interfaces for respectively connecting a television signal source, a computer and an external camera to function as a television screen, a computer display and a security monitor, respectively.

### BACKGROUND OF THE INVENTION

1. Field of the Invention

The present invention generally relates to a liquid crystal display device, and in particular to a liquid crystal display device functioning as both a television and a computer display as well as security monitor.

2. The Related Art

Data processing in today's industry and business widely utilize all kinds of memory cards for storage of video/audio data. Examples of the memory cards include memory stick and security digital memory card both are available in the market. In practical applications, the memory cards must be used in association with input devices, such as digital camera, digital video recorder, that performs writing access of the memory cards, and output devices, such as a display and computers equipped with card reading accessories, that retrieve data from the memory card.

A conventional memory card reader must be coupled with a computer or other video and audio processing system to read the memory card. Interface circuits and electrical/mechanical adaptors are commonly required for the coupling. This causes troubles to the management of electronic devices for general consumers. In addition, costs for packaging and transportation are increased. Overall costs are thus very high for general consumers.

Thus, it is desired to have a displaying device that overcomes the drawbacks commonly observed in the conventional devices.

### SUMMARY OF THE INVENTION

Thus, a primary object of the present invention is to provide a liquid crystal display device that directly reads and displays video/audio data stored in an electronic memory card.

Another object of the present invention is to provide a liquid crystal display device that functions as both a television screen and a computer display as well as a security monitor.

To achieve the above objects, in accordance with the present invention, there is provided a liquid crystal display device comprising a casing supporting a liquid crystal display screen and defining a plurality of receiving slots for respectively receiving memory cards and memory card connectors fixed inside the casing and associated with the receiving slots for engaging the memory cards received in the receiving slots. A data processing circuit is arranged in the casing for receiving and processing image data and sound data stored in the memory card and displaying the image on the liquid crystal display screen. The data processing circuit comprises a compression/decompression circuit, an input selector, a data separator, a frequency multiplication processor, a converter and an amplifier for processing the image signals and a sound input port, a mixer, an amplifier and a speaker system for processing and broadcasting sound signals. The data processing circuit is additionally provided with interfaces for respectively connecting a television signal source, a computer and an external camera to function as a television screen, a computer display and a security monitor, respectively.

### BRIEF DESCRIPTION OF THE DRAWINGS

The present invention will be apparent to those skilled in the art by reading the following description of a preferred embodiment thereof, with reference to the attached drawing, in which:

FIG. 1 is a block diagram of a liquid crystal display device constructed in accordance with the present invention; and

FIG. 2 is a perspective view of the liquid crystal display device of the present invention.

### DETAILED DESCRIPTION OF THE PREFERRED EMBODIMENT

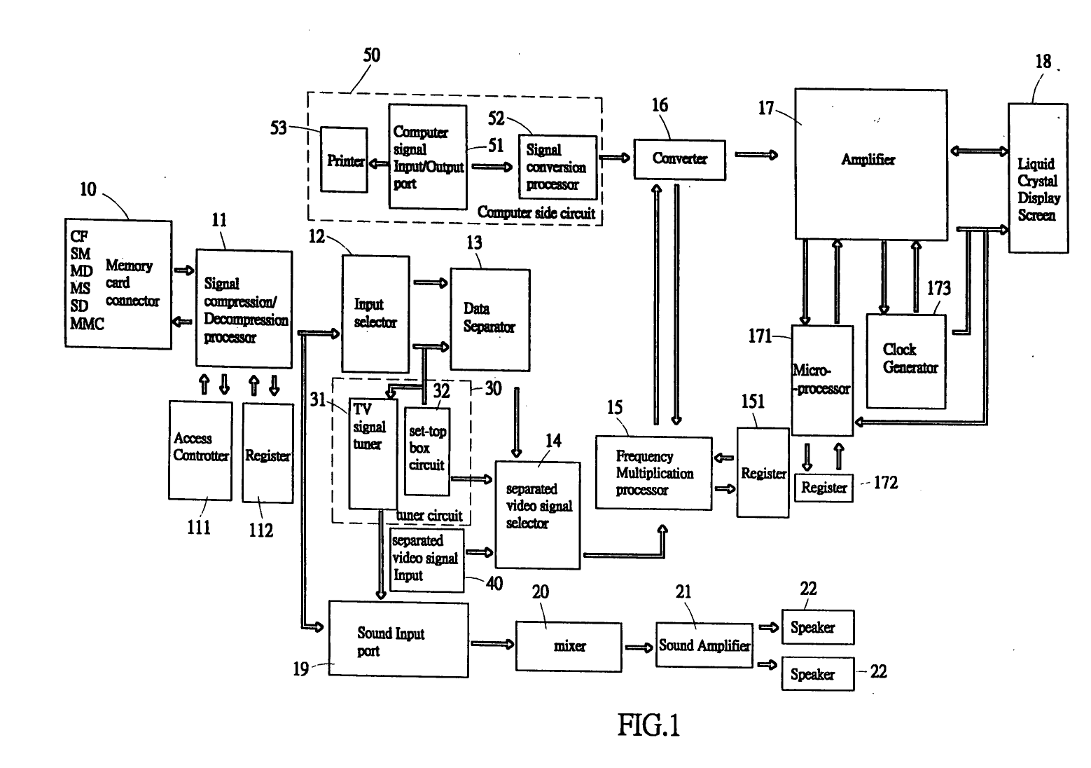

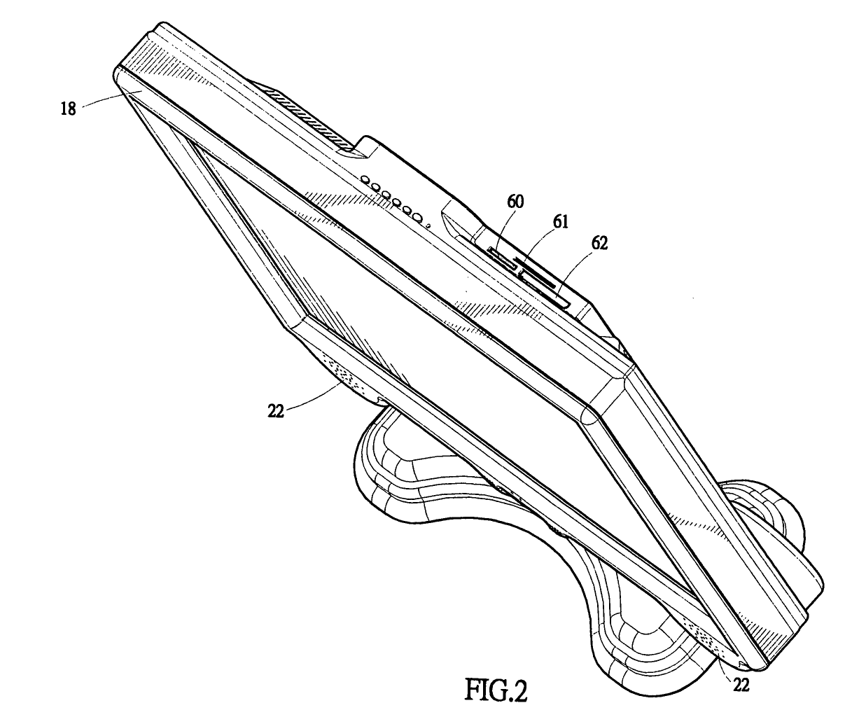

With reference to the drawings and in particular to FIG. 2, a liquid crystal display device constructed in accordance with the present invention comprises a casing (not labeled) in which card receiving slots 60, 61, 62 are defined. Card connectors 10 (FIG. 1) are arranged inside the casing and positioned in association with the card receiving slots 60, 61, 62. Electronic memory cards (not shown) are removably insertable into the card receiving slots 60, 61, 62 and engageable with the card connectors 10 for access of video/audio data stored therein by a data processing circuit of the liquid crystal display device. The video/audio data are processed by the data processing circuit and displayed and broadcast through a liquid crystal display screen 18 and a speaker system 22.

Also referring to FIG. 1, the data processing circuit comprises a signal compression/decompression processor 11, an input selector 12, a data separator 13, a frequency multiplication processor 15, a converter 16 and a signal amplifier 17 for processing video data retrieved from the memory cards or obtained from other sources that is then displayed on the display screen 18.

The card receiving slots 60, 61, 62 and the associated card connectors 10 are configured to mate different kinds of electronic memory cards available in the market, such as CF, SM, MD, MS, SD, and MMC. The signal compression/decompression processor 11 comprises an access controller 111 and a data register 112 for performing compression and decompression of sound signals, image signals, photos and text data stored in the memory cards. The input selector 12 selects the image signals, photos and text data among all input signals, while an audio input port 19 is separately provided for receiving sound signals that are then applied to a mixer 20. The data separator 13 separates digital image signals and photos and the separated signals and photos are transferred to a separated video signal input selector 14 and then the frequency multiplication processor 15 that comprises a data register 151. The signals that are processed by the frequency multiplication processor 15 is converted by the converter 16 and transmitted to the signal amplifier 17. The amplifier 17 comprises a microprocessor 171, a data register 172 and a clock generator 173. The amplifier 17 provides adjustment for the digital signal and applied the processed signal to the display screen 18 to be displayed thereby.

The sound signals are applied to the sound input port 19 located downstream the signal compression/decompression processor 11 and then the mixer 20 and an amplifier 21 to be broadcast by the speaker system 22.

The sound input port 19 comprises analog audio signal input terminal and digital audio signal input terminal. The mixer 20 mixes the analog and digital audio signals together, which is then amplified by the amplifier 21 and broadcast by the speaker system 22.

Additional input ports are also provided in the data processing circuit, including a separated video signal input port 40 through which an external video signal source, such as outdoor or indoor video camera (not shown), can be connected to the liquid crystal display device whereby the liquid crystal display device of the present invention can function as a security monitor for security watch by means of outdoor or indoor cameras.

The data processing circuit also comprises a tuner circuit 30 that comprises a television signal tuner 31 and a set-top box circuit 32 that receives and processes television signals from for example a television cable. Thus, the display screen 18 may also function as a television screen.

The data processing circuit comprises a computer side circuit 50 comprised of a computer signal input/output port 51, a signal conversion processor 52, and a printer 53. This allows the data processing circuit to be electrically coupled to a computer system (not shown) and receives data from and transmits data to the computer system.

To this point, it is understood that the liquid crystal display device comprises a number of card readers for different memory cards. Thus, data stored in the memory cards can be directly accessed by the data processing circuit of the liquid crystal display device for displaying on the screen 18. No additional adaptor and interface is needed. Coupling between a display device and a memory card can thus be significantly simplified.

The liquid crystal display device comprises a number of input ports for respectively coupling with different signal sources, such as a computer, a television cable and a security camera. Thus, the screen 18 of the liquid crystal display device may serve as a computer display, a television screen and a security monitor. Overall costs are thus reduced and the performance of a single device is enhanced.

Although the present invention has been described with reference to the preferred embodiment thereof, it is apparent to those skilled in the art that a variety of modifications and changes may be made without departing from the scope of the present invention which is intended to be defined by the appended claims.

1. A liquid crystal display device comprising:
a casing supporting a liquid crystal display screen and defining a plurality of receiving slots for respectively receiving memory cards;
memory card connectors fixed inside the casing and associated with the receiving slots for engaging the memory cards received in the receiving slots;
a data processing circuit arranged in the casing for receiving and processing at least image data, sound data and photos stored in the memory cards and selectively displaying and broadcasting the data by means of the screen and a speaker system coupled to the data processing data.

2. The liquid crystal display device as claimed in claim 1, wherein the data processing circuit comprises a signal compression/decompression circuit for performing compression and decompression on the image data, sound data and photos stored in the memory cards, an input selector for selecting image data, photos and text data, a sound input port receiving the sound data that are then applied to a mixer, a data separator for separating digital image data which are then processed by a separated video signal input selector and transmitted to a frequency multiplication processor by which the image is processed and applied to a converter and a signal amplifier, which comprises a microprocessor, a data register, and a clock generator, data processed by the amplifier being forwarded to the display screen to be displayed thereby.

3. The liquid crystal display device as claimed in claim 1, wherein the data processing circuit comprises a sound input port, a mixer, and a sound amplifier that are arranged downstream the signal compression/decompression circuit for providing signals to a speaker system.

4. The liquid crystal display device as claimed in claim 1, wherein the data processing circuit comprises a separated video signal input port for coupling to and receiving video signal from an external video signal source whereby the liquid crystal display device functions as a security monitor.

5. The liquid crystal display device as claimed in claim 1, wherein the data processing circuit comprises a tuner circuit comprised of a television signal tuner and a set-top box circuit for receiving and processing television signals whereby the liquid crystal display functions as a television screen.

6. The liquid crystal display device as claimed in claim 1, wherein the data processing circuit comprises a computer side circuit comprised of a computer signal input/output port, a signal conversion processor and a printer for receiving/transmitting and processing data from/to a computer system whereby the liquid crystal display device functions as a computer display.
